(19) United States
(12) Patent Application Publication
(10) Pub. No.: US 2025/0229329 A1
(43) Pub. Date: Jul. 17, 2025

(54) METHOD FOR PRODUCING A SINTERED HYBRID COMPONENT

(71) Applicant: Rolls-Royce Deutschland Ltd & Co KG, Blankenfelde-Mahlow (DE)

(72) Inventor: Katharina HORKE, Erlangen (DE)

(21) Appl. No.: 17/912,131

(22) PCT Filed: Mar. 3, 2021
(86) PCT No.: PCT/EP2021/055706

§ 371 Date: Mar. 7, 2025

(30) Foreign Application Priority Data
Mar. 16, 2020 (DE) 10 2020 107 105.1

(51) Int. Cl. B22F 7/02; B22F 3/22; B22F 10/18; B22F 10/64; B33Y 10/00; B33Y 40/20

(52) U.S. Cl. CPC B22F 7/02; B22F 3/225; B22F 10/18; B22F 10/64; B33Y 10/00; B33Y 40/20; B22F 2998/10

(57) ABSTRACT

The invention relates to a method for producing a sintered hybrid component, having the steps of: producing the component in a green, brown, or sintered state, said production process including the process of producing a green body of the component in an injection molding process using an injection moldable powder-binder mixture; modifying the component by applying material onto the component using an additive manufacturing process, wherein the material applied by means of the additive manufacturing process consists of a powder-binder mixture, from which the binder can be removed and which can be sintered; removing the binder from the modified component; and sintering the modified component in order to provide a sintered hybrid component.

### DESCRIPTION

The invention relates to a process for producing a sintered hybrid component part.

Powder injection molding methods (also referred to as PIM) are known in principle. They firstly include metal powder injection molding (MIM), and secondly ceramic powder injection molding (CIM). Powder injection molding methods are used in the case of high numbers of the component part to be produced. They are less suitable for single parts or small runs.

It is an object of the present invention to adapt a powder injection molding method such that it is also suitable for production of single parts and small runs.

This object is achieved in accordance with the invention by a process having the features of claim 1. Configurations of the invention are specified in the dependent claims.

Accordingly, the invention provides a process for producing a sintered hybrid component part, in which, in a first step, a component part is produced in the green, brown or sintered state, wherein the producing comprises the production of a green component part by injection molding with an injection-moldable bulk powder-binder mixture. The powder used may be metal powder and/or ceramic powder, including powders composed of cemented carbide and/or cermets, mixed with a binder.

In a further step, the component part is modified by applying a material by means of an additive manufacturing method, where the material applied by means of the additive manufacturing method consists of a powder-binder mixture which is debinderable and sinterable. This is followed by debindering of the modified component part and sintering of the modified component part for provision of a sintered hybrid component part.

The present invention is based on the idea of modifying a component part produced via a powder injection molding method using an additive manufacturing method in order to provide further structures and functions of the component part. The modification by an additive manufacturing method here enables individualization of the component parts produced by the powder injection molding method and hence permits achievement of single parts and small runs as well on the basis of the powder injection molding method.

It is envisaged here in the invention that the material applied by means of the additive manufacturing method, just like the green body produced by powder injection molding, undergoes debindering and sintering. The material used in the additive manufacturing method accordingly consists of a powder-binder mixture suitable for being debindered and sintered.

The inventive combination of a powder injection molding method and an additive manufacturing method permits the provision of better surface accuracy of the component part produced compared to a purely additive manufacturing method. Furthermore, the powder injection molding method can provide hollow structures, for example cooling structures in a turbine blade, with better surface quality than is possible by a purely additive manufacturing method. The additive manufacturing method can achieve individualization and extension of function of the component parts produced by the powder injection molding method.

The component part in the first process step is produced in the green, brown or sintered state, i.e. as a green part, brown part or sintered part. Depending on this, it is necessary or no longer necessary to debinder and to sinter the component part after application of material by means of the additive manufacturing method. Three cases should be considered here.

When the component part in the green state is being modified by the additive manufacturing method, the component part and its modification are collectively in the green state. The modification gives rise to a hybrid green body. This hybrid green body, i.e. the component part in the green state and the material applied, are collectively debindered and sintered, forming a sintered hybrid component part.

When the component part in the brown state is modified by the additive manufacturing method, application of the material to the component part is followed by debindering solely of the material applied since the component part produced by the injection molding method is already in the brown state, i.e. has already been debindered. This does not rule out subjecting of the modified component part as a whole to the process of debindering, which comprises, for example, leaching out the binder chemically or driving out the binder thermally. Since the component part produced by the injection molding method has already been debindered, all that is actually done is that the material applied by means of the additive manufacturing method is debindered. Alternatively, it may be the case that the subject of the process steps for debindering is solely the material applied by means of the additive manufacturing method.

The debindering of the material applied gives rise to a hybrid brown body (also referred to as brown part) comprising the component part produced by the injection molding method and the material applied in the brown state. This hybrid brown part is then sintered to form a sintered hybrid component part.

It is pointed out that there exist variants of debindering in which multiple binder components are removed sequentially. For example, it may be the case that the binder has a first binder component which is removed by solvent, and has a second binder component which is removed thermally. In such variants, the component part is referred to as a brown body even when only one binder component has been removed.

It may be the case here in such cases of multiple debindering that the component part is modified by the additive manufacturing method after the first binder component has been removed or after both or all binder components have been removed. Binder components that are yet to be removed are likewise removed here in the process of debindering the material applied.

When the component part in the sintered state is modified by the additive manufacturing method, application of the material is followed by debindering and sintering solely of the material applied. This in turn does not rule out that even the already sintered component part once again undergoes the corresponding processes in the debindering and sintering. Alternatively, it may be the case that the subject of the process steps for debindering and sintering is solely the material applied by means of the additive manufacturing method.

The result is again a sintered hybrid component part comprising the component part produced by the injection molding method and the material applied in the sintered state.

In one configuration of the invention, the component part is modified by mounting an additional structure on the component part. The additional structure here implies an additional function and/or property of the component part. In one working example in this regard, the additional structure provides a snap-fit, positioning and/or connecting structure of the component part.

In a further configuration of the invention, the component part is modified by applying at least one layer on at least one surface of the component part. This especially enables a change in the material properties of the component part in the region of the new surface applied. In one working example in this regard, the additive manufacturing method is used to apply to the component part a layer that provides protection from oxidation, protection from corrosion and/or protection from erosion.

In a further configuration of the invention, the component part is modified by mounting an additively manufactured component on the component part, wherein the additively manufactured component bonds the component part to a further component part. The additively manufactured component in this working example thus serves to bond the component part to a further component part. In execution variants, it may be the case here that the additively manufactured component is mounted on the component part using a removable support structure, wherein the support structure firstly serves as a spacer between the component part and the further component part and secondly enables a desired shaping of the additively manufactured component by provision of a contact surface. The support structure is removed again after mounting of the additively manufactured component.

In one execution variant, the component part and the further component part are additionally joined directly. This can be effected, for example, via sinter joining, pasting or by push-fit connections. The applying of the additive component here provides a further join. The additive component may optionally enable additional functionalization of the component part, optionally by formation of suitable structures.

In configurations of the invention, the sintered hybrid component part is subjected to hot isostatic pressing and/or heat treatment. This serves for further compaction of the component part and the establishment of desired material properties. Additionally or supplementarily, it may be the case that the sintered hybrid component part undergoes mechanical reprocessing, for example in order to reduce tolerances.

The powder-binder mixture used in the additive manufacturing method may be the same powder-binder mixture with which the component part in the green, brown or sintered state has been produced. In other words, the feedstock used in the additive manufacturing is the same as that with which the powder injection molding method has been conducted. Such a configuration has the advantage of homogeneous material properties of the hybrid component part.

Alternatively, it may be the case that the powder-binder mixture used in the additive manufacturing method is a different powder-binder mixture than that with which the component part in the green, brown or sintered state has been produced.

The materials used as powder-binder mixtures in the additive manufacturing may be taken from a wide range of materials. Examples are acrylonitrile-butadiene-styrene copolymers (ABS), polyimides, polyamide PA-6, polyamide PA-66, polycarbonate (PC), thermoplastic polyurethane (TPU), polyethylene terephthalate (PET), polypropylene (PP), polylactides (PLA), ABS-PC, conventionally obtainable MIM feedstocks and MIM feedstocks in general.

The powder-binder mixture used in the additive manufacturing is provided, for example, in the form of fusible filaments. Such an additive manufacturing method is also known by the names “fused deposition modelling (FDM)” and “fused filament fabrication (FFF)”, or as the strand laying method. This is a 3D printing method in which a continuous filament of a thermoplastic material is used.

Fusible filaments suitable for the invention are sold, for example, by BASF 3D Printing Solutions GmbH under the Ultrafuse® name. This is a filament for 3D printing of a green body, wherein the green body after the 3D printing is debindered and then sintered. The Ultrafuse® filament includes thermoplastic binders with 90% by mass of high-purity metal particles.

The powders used in the powder injection molding method may be any sinterable metal powders, for example steel, iron-based powders, nickel-based powders, cobalt-based powders, titanium powders, titanium alloy powders, copper powders and powders of intermetallic phases (e.g. TiAl, FeAl). The powders used may also be ceramic powders consisting of oxide ceramics and/or of non-oxide ceramics.

Binders used are binders known from injection molding technology. The binders consist, for example, of thermoplastics and/or waxes, and additives may be added to the binder, for example stabilizers, dispersants and additions for promoting wettability.

In working examples of the invention, the component part in the green, brown or sintered state is first measured prior to modification thereof. In that case, the component part is inserted in the green, brown or sintered state into an additive manufacturing system for the purpose of modification thereof by an additive manufacturing method. A 3D CAD model is created for modification of the component part, and the component part is then modified by means of the powder-binder-based additive manufacturing method in accordance with the 3D CAD model created.

The present invention is used in execution variants for production of components of a gas turbine engine. Furthermore, the present invention can in principle also be applied to other technical fields.

In a further aspect of the invention, the invention relates to a component part of a gas turbine engine that has been produced by the process of the invention. The component part is, for example, a turbine component.

The invention is elucidated in more detail hereinafter with reference to the figures of the drawing by multiple working examples. The figures show:

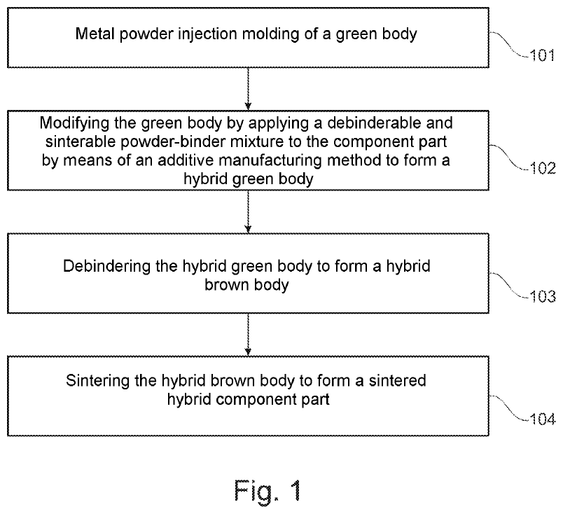

FIG. 1 a flow diagram having the process steps of a first process for producing a sintered hybrid component part;

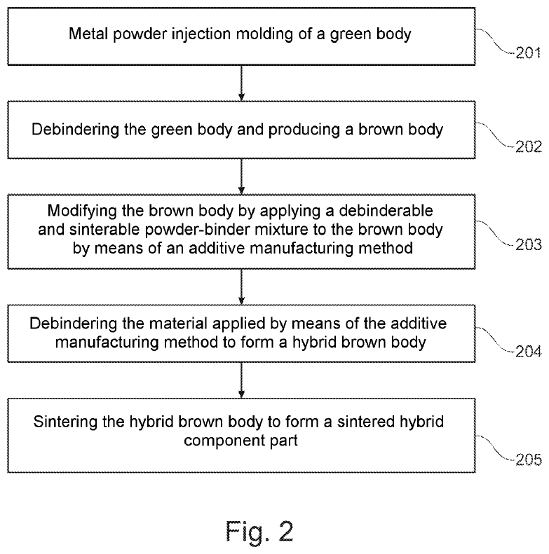

FIG. 2 a flow diagram having the process steps of a second process for producing a sintered hybrid component part;

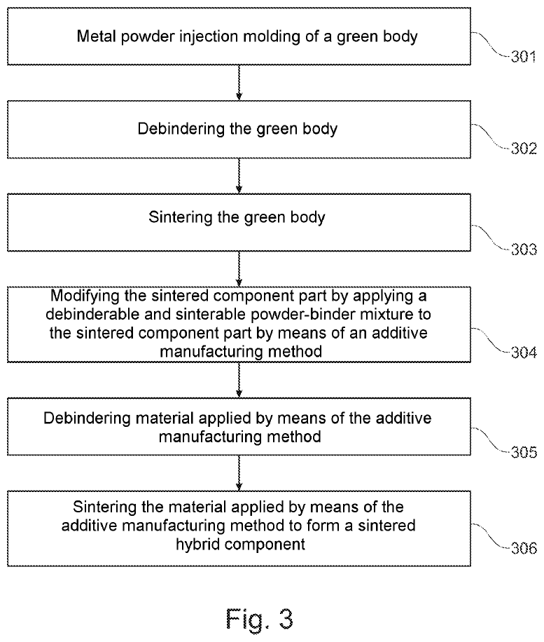

FIG. 3 a flow diagram having the process steps of a third process for producing a sintered hybrid component part;

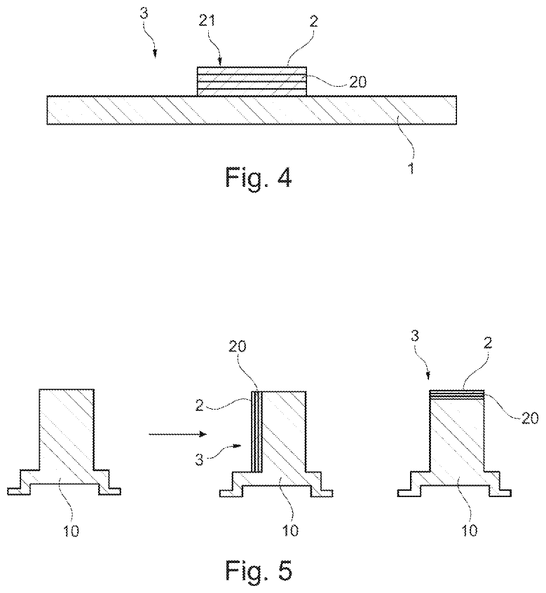

FIG. 4 a schematic diagram of a hybrid component part comprising a component part produced by metal powder injection molding and a component added thereto by additive manufacturing;

FIG. 5 a schematic of the layered construction of a functional layer on surfaces of a compressor blade of a gas turbine engine produced by metal powder injection molding, by means of additive manufacturing;

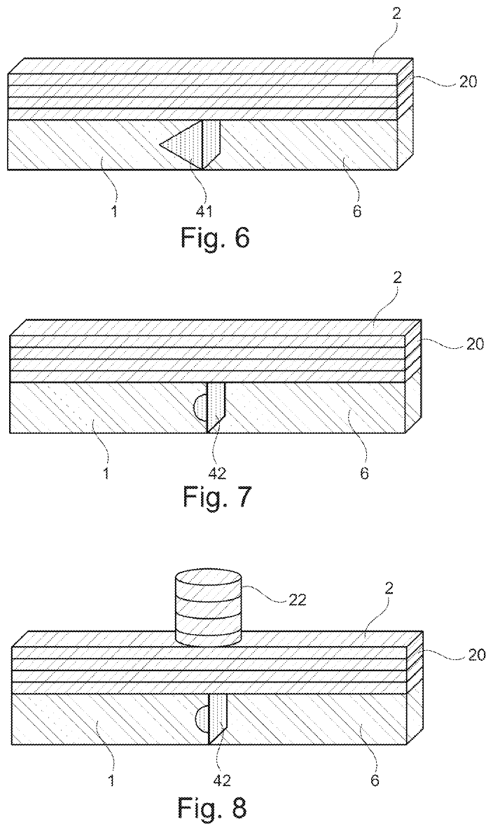

FIG. 6 a working example in which an additively manufactured component connects a first component part to a second component part, where the two component parts are additionally directly bonded to one another via a first push-fit connection;

FIG. 7 a further working example in which an additively manufactured component connects a first component part to a second component part, where the two component parts are additionally directly bonded to one another via a second push-fit connection;

FIG. 8 a further working example in which an additively manufactured component connects a first component part to a second component part, where the two component parts are additionally directly bonded to one another via a push-fit connection, and where the additively manufactured component additionally forms an added structure;

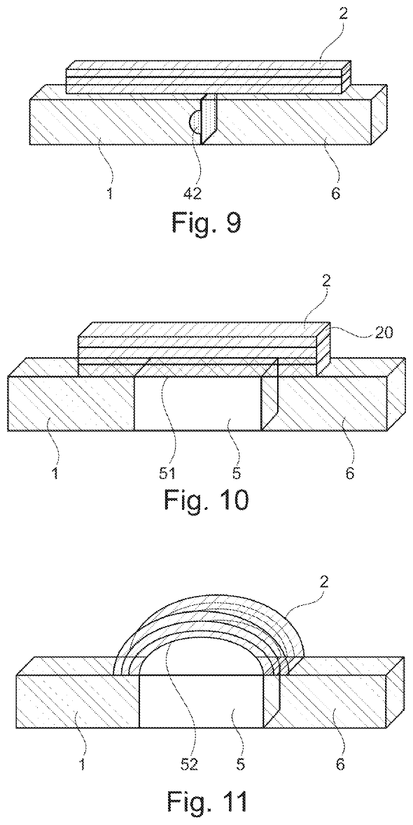

FIG. 9 a further working example in which an additively manufactured component connects a first component part to a second component part, where the two component parts are additionally directly bonded to one another via a push-fit connection, and where the additively manufactured component has smaller dimensions than the two component parts;

FIG. 10 a further working example in which an additively manufactured component connects a first component part to a second component part, where the two component parts are separated from one another by a removable spacer that serves as a flat support structure for the additively manufactured component to be applied, and

FIG. 11 a further working example in which an additively manufactured component connects a first component part to a second component part, where the two component parts are separated from one another by a removable spacer that serves as a curved support structure for the additively manufactured component to be applied.

FIG. 1 shows a working example of a first process for producing a hybrid component part, which is, for example, a hybrid component part of a gas turbine engine for an aircraft. The hybrid component part in question is, for example, a turbine component of the gas turbine engine. However, the principles of the present invention can in principle be applied to any desired component parts.

In a first process step 101, a green body is produced by metal powder injection molding. The use of the term “metal powder injection molding” here also comprises ceramic powder injection molding. For production of the green body, a feedstock comprising a powder-binder mixture is first produced, and the powder-binder mixture is then used to produce a green body by injection molding, i.e. an MIM component part in the green state.

In the subsequent process step 102, the green body is modified by applying a powder-binder mixture to the component part by means of an additive manufacturing method. The powder-binder mixture used for the additive manufacturing method here is likewise debinderable and sinterable. The powder-binder mixture may be the same as that used in the metal powder injection molding, or may be a different powder-binder mixture.

Prior to the performance of the additive manufacturing, it may be the case that the MIM component part produced in process step 101 is first measured exactly. The component part is then inserted into an additive manufacturing system. A 3D CAD model of the modified component part is further provided, and the additive manufacturing is executed for performance of the modification.

The additive manufacturing method may in principle be any known additive manufacturing method. The powder-binder mixture is provided, for example, in the form of fusible filaments (“fused filament fabrication”—FFF) consisting of a thermoplastic material comprising the binder and the powder. The fusible elements are passed through a heated extruder head of a 3D printer and deposited on the MIM component part, in which the material applied can be applied in layers and the thickness of the material applied increases gradually. The extruder head of the 3D printer is moved according to the 3D-CAD model created for the modified component part in a computer-controlled manner, in order to define the printed form.

Application of the material gives rise to a hybrid green body comprising a green body component via the metal powder injection molding and a green body component via the additive manufacturing.

In step 103, hybrid green body is debindered to form a hybrid brown body. This is effected by means of solvents and/or thermally (including a catalytic debindering), depending on the binder system used. Subsequently, the hybrid brown body is sintered in step 104 to form a sintered hybrid component part.

Optionally, step 104 is followed by a heat treatment or hot isostatic pressing of the sintered hybrid component part in order to further compact the component part. There is likewise optional mechanical reprocessing, for example in order to reduce tolerances that exist.

FIG. 2 shows a working example of a second process for producing a hybrid component part. First of all, in step 201, a green body is produced by metal powder injection molding. In this respect, reference is made to the elucidations relating to step 101 of the process of FIG. 1. Subsequently, the green body is debindered to form a brown body of the component part.

In step 203, the brown body is modified by applying a powder-binder mixture to the brown body by means of an additive manufacturing method. Step 203, with regard to the performance of the additive manufacturing, corresponds to 102 of the process of FIG. 1, and so reference is made to the details in that regard. The difference is that the powder-binder mixture in the course of additive manufacturing is applied not to the green body as in FIG. 1 but to the brown body.

Subsequently, in step 204, the material applied by means of the additive manufacturing method is debindered. For this purpose, it may be the case that solely the material applied is contacted with a solvent and/or subjected to thermal treatment (including catalytic debindering). It may alternatively be the case that the combined component part, i.e. the brown body produced by powder injection molding and the additive component, is contacted with a solvent and/or subjected to thermal treatment (including a catalytic debindering), although only the material applied by means of the additive manufacturing method is actually debindered since the brown body has already been debindered beforehand. The debindering gives rise to a hybrid brown body comprising a brown body component from the metal powder injection molding and a brown body component from the additive manufacturing.

The hybrid brown body is finally sintered in step 205 to form a sintered hybrid component part. Optionally, reprocessing can be effected by a heat treatment, hot isostatic pressing and/or mechanical reprocessing.

FIG. 3 shows a working example of a third process for producing a hybrid component part. First of all, in step 301, a green body is produced by metal powder injection molding. In this respect, reference is made to the elucidations relating to step 101 of the process of FIG. 1. Subsequently, in step 302, the green body is debindered to form a brown body of the component part. In step 303, the brown body is sintered, so as to provide a sintered MIM component part.

In step 304, the sintered MIM component part is modified by applying a powder-binder mixture to the sintered MIM component part by means of an additive manufacturing method. Step 304, with regard to the performance of the additive manufacturing, corresponds to 102 of the process of FIG. 1, and so reference is made to the details in that regard. The difference is that the powder-binder mixture in the course of additive manufacturing is applied not to the green body as in FIG. 1 or to the brown body in FIG. 2, but rather to the sintered MIM component part.

Subsequently, in step 305, the material applied by means of the additive manufacturing method is debindered. For this purpose, it may be the case that solely the material applied is contacted with a solvent and/or subjected to thermal treatment (including catalytic debindering). It may alternatively be the case that the combined component part, i.e. the component part sintered by metal powder injection molding and the additive component, is contacted with a solvent and/or subjected to thermal treatment (including a catalytic debindering), although only the material applied by means of the additive manufacturing method is actually debindered since the sintered component part has already been debindered and sintered beforehand.

Subsequently, in step 306, the material applied by means of the additive manufacturing method is sintered to form a sintered hybrid component part comprising a sintered component via the metal powder injection molding and a sintered component via the additive manufacturing.

It may be the case here that only the material applied is sintered. Alternatively, it may be the case that the combined component part, i.e. the component part sintered by metal powder injection molding and the additive component, is sintered, in which case the component part produced by metal powder injection molding is thus sintered once again.

FIG. 4 shows a schematic of a sintered hybrid component part 3 consisting of a component part 1 produced by metal powder injection molding and a component 2 applied to the component part 1 by means of an additive manufacturing method. Component 2 may have been applied here to component part 1 in the green, brown or sintered state, as elucidated in relation to FIGS. 1-3. Component 2 may consist of multiple layers 20.

It is pointed out that component 2 formed by application of material also forms a structure 21 on the component part 1, by means of which an additional functionality of the hybrid component part 3 may be provided. For example, the structure 21 serves a positioning function, for example a centering function relative to other component parts. In other examples, the structure 21 serves a snap-fit function or connecting function.

FIG. 5 shows a further working example in which multiple layers 20 of a material 2 are applied by additive manufacturing of a surface of a component part 10 produced by metal powder injection molding, wherein the material 2 provides a functional layer that provides, for example, protection from oxidation, protection from corrosion or protection from erosion. The material 2 may have been applied on different surfaces of the component part 10. The component part is a sintered hybrid component part 3 having a component 10 produced by metal powder injection molding and a component 2 produced by additive manufacturing.

FIG. 6 shows a working example in which a component part 1 is connected to a component 2 produced by additive manufacturing, wherein component 2 connects component part 1 to a further component part 6. It is the case here that component parts 1, 6 are additionally connected to one another here by a join 41. The additive component 2 here provides a further join. The direct join 41 follows a push-fit connection, for example, wherein FIG. 6 shows, by way of example, a first working example of such a push-connection in which one component part forms a prismatic projection. Alternatively, the direct join is effected, for example, by sinter joining or via pasting.

The working example of FIG. 7 corresponds to the working example of FIG. 6, apart from the fact that a join 42 is provided that implements another push-fit connection in which one component part forms a hemispherical projection.

The working example of FIG. 8 corresponds to the working example of FIG. 7, apart from the fact that the additively manufactured component 2 additionally forms a protruding structure 22, the shape of which is shown merely by way of example in FIG. 8. The protruding structure 22, just like the structure 21 elucidated in relation to FIG. 4, may fulfill a snap-fit function and/or positioning function and/or connecting function or else another function.

FIG. 9 illustrates schematically that the additively manufactured component 2 may have different dimensions than component parts 1, 6.

FIG. 10 shows a working example in which a support structure 5 disposed between the two component parts 1, 6 serves firstly as a spacer between the two component parts 1, 6. The surface 51 of the support structure 5 serves secondly as the contact surface for the additively manufactured component 2, such that this can be applied between the two component parts 1, 6 in spite of the space between them. The support structure 5 is removed again after mounting of the additively manufactured component 2. This can be effected immediately after mounting of the additively manufactured component 2 or, for example, only on sintering.

FIG. 11 shows a modification of the working example of FIG. 10, in which the additively manufactured component 11 is curved. For this purpose, the support structure 5 has a curved surface 52, onto which the applied material is deposited in the additive manufacturing.

It will be apparent that the invention is not restricted to the embodiments described above, and various modifications and improvements can be undertaken without departing from the concepts described here. Furthermore, except where mutually exclusive, any of the features may be used separately or in combination with any other features, and the disclosure extends to and includes all combinations and sub-combinations of one or more features that are described herein. If ranges are defined, said ranges thus comprise all of the values within said ranges as well as all of the partial ranges that lie within a range.

1. A process for producing a sintered hybrid component part, comprising the steps of:
producing a component part in the green, brown or sintered state, where the producing comprises the production of a green component part by injection molding with an injection-moldable powder-binder mixture,
modifying the component part by applying a material to the component part by means of an additive manufacturing method, where the material applied by means of the additive manufacturing method consists of a powder-binder mixture which is debinderable and sinterable,
debindering the modified component part, and
sintering the modified component part to provide a sintered hybrid component part.

2. The process as claimed in claim 1, wherein the component part in the green state is modified by the additive manufacturing method, where the component part in the green state and the material applied are debindered and sintered together.

3. The process as claimed in claim 1, wherein the component part in the brown state is modified by the additive manufacturing method, where application of the material to the component part in the brown state is followed by debindering of the material applied and then sintering of the resultant hybrid brown component part.

4. The process as claimed in claim 1, wherein the component part in the sintered state is modified by the additive manufacturing method, where application of the material is followed by debindering and sintering of the material applied.

5. The process as claimed in claim 1, wherein the component part is modified by mounting an additional structure on the component part.

6. The process as claimed in claim 5, wherein the additional structure provides a snap-fit, positioning and/or connecting structure of the component part.

7. The process as claimed in claim 1, wherein the component part is modified by applying at least one layer on at least one surface of the component part.

8. The process as claimed in claim 7, wherein the additive manufacturing method is used to apply a layer to the component part that provides protection from oxidation, protection from corrosion or protection from erosion.

9. The process as claimed in claim 1, wherein the component part is modified by mounting on the component part an additively manufactured component that bonds the component part to a further component part.

10. The process as claimed in claim 9, wherein the additively manufactured component is mounted on the component part using a removable support structure, where the support structure serves as a spacer between the component part and the further component part.

11. The process as claimed in claim 9, wherein the component part and the further component part are additionally joined directly.

12. The process as claimed in claim 1, wherein the sintered hybrid component part is subjected to hot isostatic pressing and/or heat treatment.

13. The process as claimed in claim 1, wherein the powder-binder mixture used in the additive manufacturing process is the same powder-binder mixture with which the component part has been produced by injection molding.

14. The process as claimed in claim 1, wherein the powder-binder mixture used in the additive manufacturing process is a different powder-binder mixture than that with which the component part has been produced by injection molding.

15. The process as claimed in claim 1, wherein the powder-binder mixture used in the additive manufacturing process is provided in the form of a fusible filament for 3D printing.

16. (canceled)

17. (canceled)

18. The process as claimed in claim 1, wherein the component part is measured in the green, brown or sintered state prior to modification thereof.

19. The process as claimed in claim 1, wherein the component part in the green, brown or sintered state, for the purpose of modification thereof by an additive manufacturing method, is inserted into an additive manufacturing system, a 3D CAD model for modification of the component part is created, and the component part is then modified by means of the powder-binder-based additive manufacturing method in accordance with the 3D CAD model created.

20. The process as claimed in claim 1, wherein the hybrid component part produced is a component of a gas turbine engine.
